(19) United States
(12) Patent Application Publication
(10) Pub. No.: US 2021/0347064 A1
(43) Pub. Date: Nov. 11, 2021

(54) Reach-through Window Allowing Safe Touch Without Direct Contact

(71) Applicant: Cythia Renee Shinabarger, Newnan, GA (US)

(72) Inventor: Cythia Renee Shinabarger, Newnan, GA (US)

(21) Appl. No.: 17/302,338

(22) Filed: Apr. 30, 2021

Related U.S. Application Data
(60) Provisional application No. 62/704,425, filed on May 9, 2020.

(51) Int. Cl. B25J 21/02; A61G 10/00

(52) U.S. Cl. CPC B25J 21/02; A61G 10/005

(57) ABSTRACT

A reach-through visitation window designed to offer solutions to the deficiencies of traditional window visits by providing safe touch without direct contact for those meeting with visitors while in medical quarantine. The visitation window can include HEPA filter hearing panels to provide safe transmission of sound for natural, mask-free conversation without the need for electronics. Medical grade protective sleeves attached to the reach-through ports accommodate disposable gloves to ensure complete isolation between the resident and the visitor. The easily removable reach-through window fits into the screen track of the existing facility window system once the screen is removed and is secured in the same manner as the screen thus requiring no facility modifications. In most cases the reach-through visitation window can be left in place while the primary window is lowered and locked to secure the facility, or it can be easily removed until the next scheduled visit.

### FIELD

The present invention relates to a removeable visitation window with reach-through ports allowing gloved hands to be inserted through arm inserts and into protective sleeves, providing the ability to safely touch those on the opposite of the window without fear of cross contamination. High-efficiency Particulate Air (HEPA) filter panels provide safe transmission of sound for natural, mask-free conversation. The window fits securing into the existing screen or window track thus requiring no remodeling of the structure.

### BACKGROUND

To combat the spread of contagious viruses or protect those who are immune compromised, vulnerable individuals are quarantined. While the intent of this isolation is to physically protect the individuals, it leaves them touch deprived and separated from loved ones greatly impacting their mental health. When quarantine occurs in a resident facility for the elderly or those with mental or physical impairments, the impact to their mental health can be devastating.

While phone calls, video chats and traditional window visits provide some benefit for the loneliness, they do not provide a solution for touch deprivation. For those suffering from cognitive impairment, aphasia, vision, or hearing issues even these options are not viable as they create confusion. Those individuals cannot understand or use the technology; they are upset by being able to see or hear their loved ones without being able to touch them. They are left with no way to communicate with those they love during the entire length of the quarantine.

In view of the above, a need exists for improving the safe visitation options for those isolated during medical quarantine. Those improvements must address the entire health of the resident, physically, mentally, and socially and provide accessibility for those with cognitive and physical impairments.

### SUMMARY

The following disclosure describes the present invention, a novel device and method, to address the current deficiencies in visitation options for those in quarantine. The Summary is non-limiting and should not be construed as representative of the full extent and the scope of the present invention.

The window device was created to provide quarantined individuals the ability to touch and hold hands with their visitors, hear their natural voice through High-efficiency Particulate Air (HEPA) filters and clearly see them mask-free without compromise to their safety. It reduces the effect of touch deprivation and loneliness that accompanies isolation by providing an interactive, enhanced and medically safe window visit. The simplicity of the device and the installation into existing facility window systems without modifications, makes this a practical and cost effective solution.

The window device according to the present invention comprises a clear non-glass sheet with apertures, flexible edge trim, urethane rubber arm inserts, antimicrobial medical grade polyurethane laminate (PUL) sleeves, HEPA filters and associated removal hardware.

When fully assembled and fit firmly in the track of a facility window system, the reach-through visitation window device provides an isolation barrier between the visitor and resident. The over lapping edges of the HEPA filters and arm inserts provide gasketing as the components are firmly attached to the sheet. A visitor wearing disposable gloves which have been disinfected can gain access to the resident side of the window through the access portals created by the arm inserts and sleeves which are securely affixed between the arm inserts and the sheet.

Additional aspects of the present invention will become more readily apparent from the Detailed Description, particularly when taken in conjunction with the drawings.

### BRIEF DESCRIPTION OF THE DRAWINGS

Some examples of the present invention are illustrated herein and are not limited by the figures of the accompanying drawings.

FIG. 1 is an isometric view of the window apparatus viewed from the inside/resident side.

FIG. 2 is an isometric view of the window apparatus viewed from the outside/visitor side.

FIG. 3 is an exploded view of the major components of window apparatus viewed from the inside/resident side.

FIG. 4 is an isometric view of the urethane rubber arm insert.

FIG. 5 is an isometric view of the antimicrobial medical grade sleeve.

FIG. 6 is an exploded view of the arm insert, sleeve and associated hardware.

FIG. 7 is an exploded view of the HEPA filter hearing panel and associated hardware.

FIG. 8 is an isometric view of a completed window apparatus in use with the visitor wearing the required disposable gloves.

FIG. 9 is a flow diagram detailing the method by which the apparatus is installed and used.

### DETAILED DESCRIPTION

The present invention relates to the apparatus and method for a safe touch, reach-through window visit.

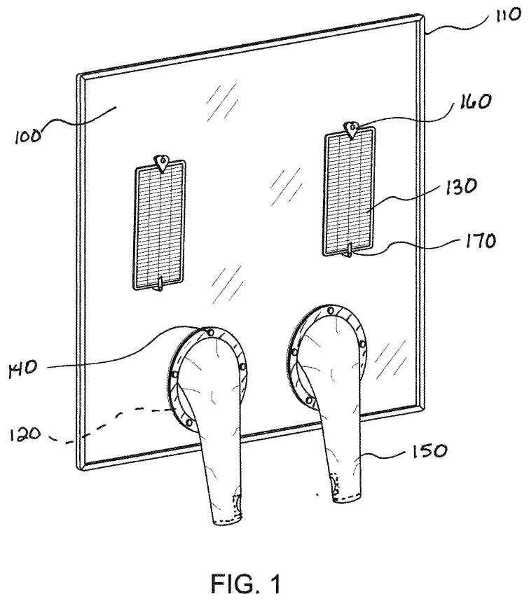

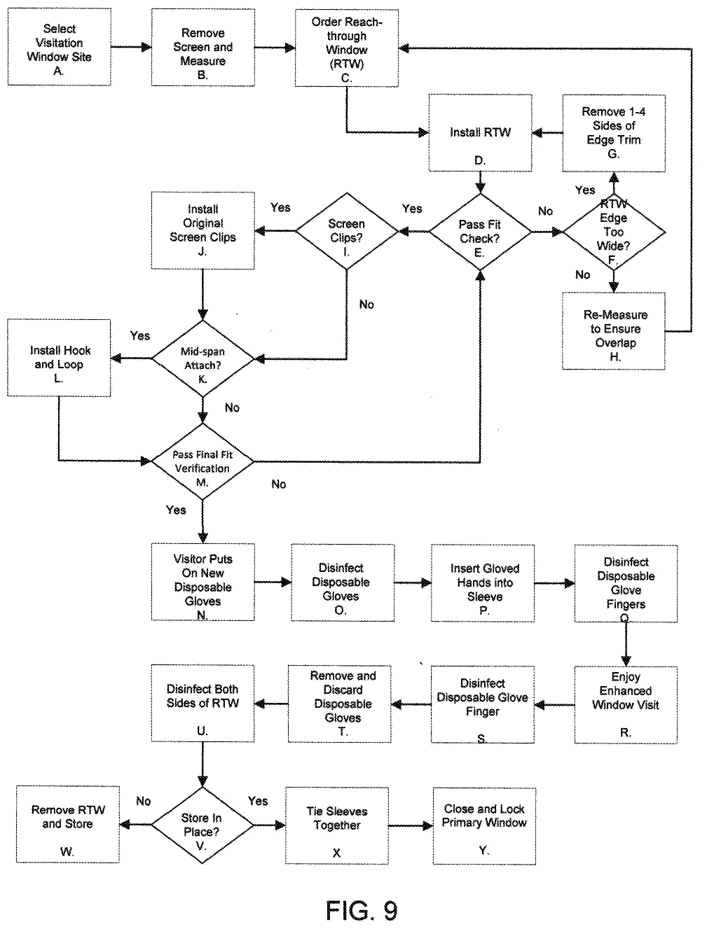

Referring now to the drawings wherein the purpose is one of illustrating non-limiting embodiments of the invention only and not for the purpose of limiting same, FIGS. 1-8 illustrate one embodiment of the reach-through window in accordance with the present invention. FIG. 9, a flow diagram, details the method for installation and use of the window apparatus. The shape, size, configuration, number and size of hearing panels and location of the reach-through window are non-limiting. The materials and colors of the reach-through window are also non-limiting. Generally, the materials used to form the reach-through window include material that are UV resistant; however, that is not required.

The reach-through window is generally designed to fit tightly into the existing screen track of a facility window system once the screen is removed. The size of the reach-through window apparatus is that of the window screen including the frame. The reach-through window is secured in the track in the same manner as the said screen if any means of securing is necessary. In some larger embodiments of the invention one or more small pieces of outdoor hook and loop tabs can be applied at the edge between the reach-through window and the window system frame to further guarantee that the device firmly abuts the window system frame around the entire perimeter.

In most window systems, the reach-through window can be left in place in the screen track while the primary window is closed and locked to secure the building; however, this is not required as the reach-through window can be easily removed and re-installed when needed. The reach-through window can also be installed in the primary window track of a double or single hung window and the primary window lowered to secure in place.

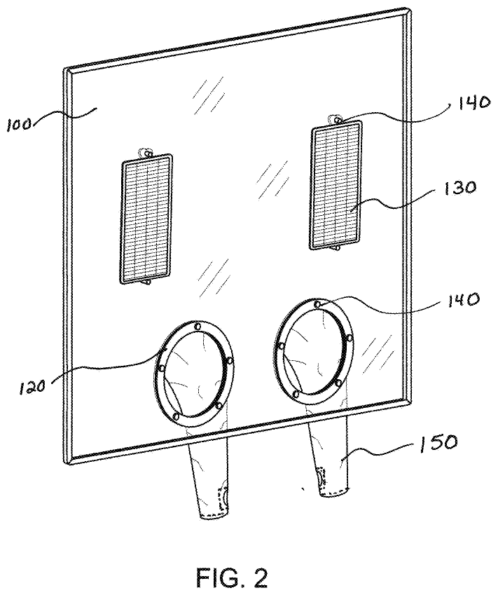

FIG. 1 illustrates the main components of the reach-through window from the resident side. The outer edge of the non-glass clear sheet 100 is wrapped with flexible polyvinyl chloride plastic (PVC) edge trim 110 which acts as an edge protector and helps hold the window apparatus firmly in the track. In this embodiment the non-glass clear sheet is ¼″ thick acrylic. In some embodiments of the present invention, this edge trim 110, may be removed on one or more sides to allow fitting in a thinner profile track. HEPA hearing panels 130 are inserted and secured in apertures cut in the sheet 100. In this embodiment, the HEPA filter panels consist of readily available size H cartridges. A plurality of holes drilled in the sheet 100 accommodate removeable hardware is detailed in FIG. 7. Antimicrobial medical grade PUL sleeves 150 are secured between the molded urethane rubber arm inserts 120 and the sheet 100 on the visitor side as detailed in FIG. 2 with majority of the sleeve length fed through the aperture in the sheet 100 and into the resident side. The hearing panels 130 are held in place by powder coated aluminum heart clips 160 and a plastic lever clip 170 secured with the hardware shown in FIG. 7.

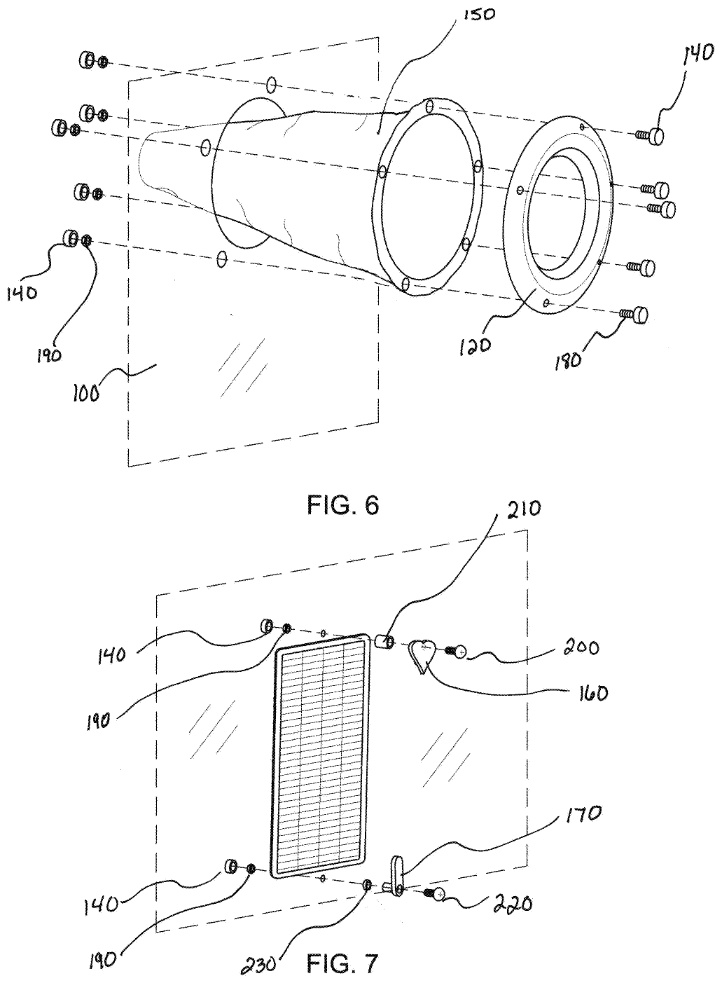

The arm inserts 120 are only visible on the resident side through the non-glass clear sheet however the plastic hinged snap cap hardware covers 140 covering the removable hardware as detailed in FIG. 6 are visible on the resident side.

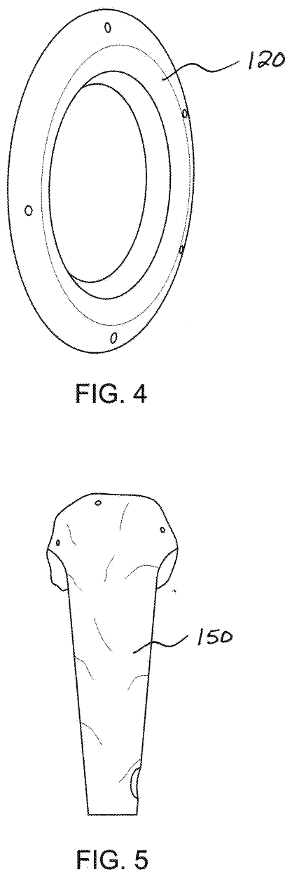

FIG. 2 illustrates the main components of the reach-through window from the visitor side. In addition to the components described above, the outer collar of the molded urethane rubber arm inserts 120 is visible from this side and acts as a gasket, holding the antimicrobial medical grade PUL sleeves 150 securely against the non-glass clear sheet 100. The sleeves 150 are positioned under the outer collar and around the inner cylindrical portion of each arm insert 120 detailed in FIG. 4. A plurality of holes in each of the sleeves 150 is aligned with corresponding holes in the arm inserts 120 and sheet 100; the assembly is clamped in place by the removeable hardware detailed in FIG. 6. The plastic hinged snap cap hardware covers 140 covering the removable hardware for the HEPA hearing panels 130 are visible from the visitor side as detailed in FIG. 7.

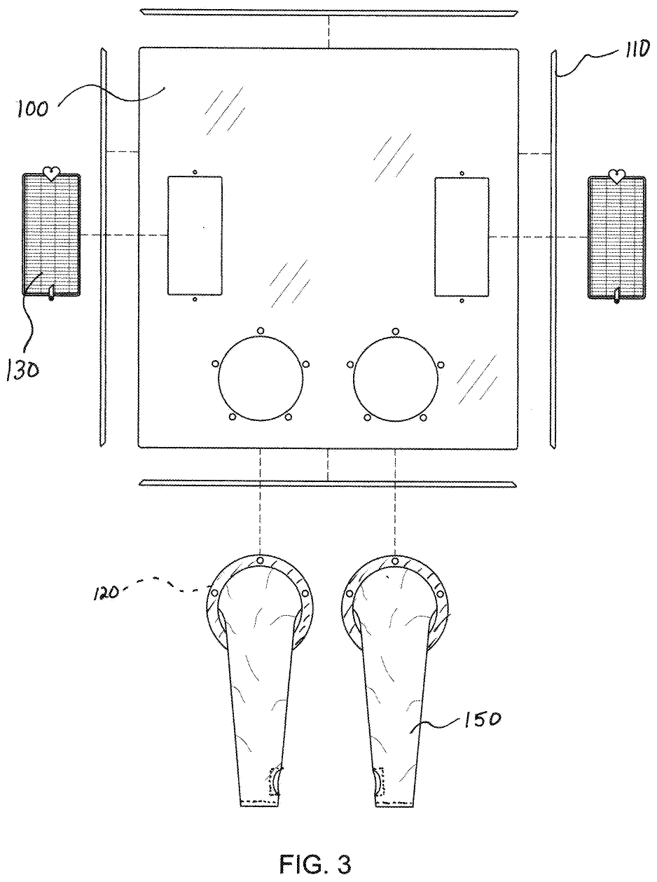

The exploded view shown in FIG. 3 clearly indicates the apertures and hardware holes cut in the non-glass clear sheet 100 for this embodiment of the invention. The flexible polyvinyl chloride plastic (PVC) edge trim 110 is typically one piece and mitered at each corner. On occasion, one or more sides of the trim may need to be removed to fit in the screen track properly. The trim can easily be cut at the corners and the side(s) removed without affecting the fit or function of the remaining trim. The molded urethane rubber arm inserts 120 are shown in this resident-side view but hashed to indicate they reside on the visitor side. The arm inserts 120 firmly press the top of the antimicrobial medical grade PUL sleeves 150 against the sheet 100 resulting in the shape indicated in the figure. Details of the removable hardware for the arm insert 120 and HEPA filter hearing panels are shown in FIGS. 6 and 7, respectively.

FIG. 4 details the shape of the molded urethane rubber arm inserts 120. The outer diameter is approximately 8.5″ and acts as a collar and provides gasketing to the non-glass clear sheet 100 and secure attachment of the upper portion of the antimicrobial medical grade PUL sleeves 150. The inner diameter is approximately 6.0″ and is located at the end of a cylindrical protrusion from the said collar resulting in a funnel shape, which when placed through the aperture in the sheet 100 creates a comfortable armrest for the visitor while ensuring the portal is completely engulfed in the sleeve 150 as described in FIG. 2. Holes introduced during the molding of the arm inserts 120 allow for proper alignment of the insert 120 and the sleeves 150 to the sheet and secure attach via the removable hardware detailed in FIG. 6.

FIG. 5 details a sleeve 150 made of antimicrobial medical grade PUL fabric, indicating the non-limiting location of the thumb hole used to anchor the thumb and position the visitor hand in the sleeve. The conical fingerless sleeve 150 is constructed with a single side seam and hemmed at the narrow end and around the thumb anchor. In this embodiment the sleeve is approximately 23″ long. The holes along the top edge provide alignment between the molded urethane rubber arm inserts 120 and the non-glass clear sheet 100 on the visitor side. The remainder of the sleeve 150 is positioned through the aperture in the sheet 100 and completely encompassing the inner cylinder of the arm inserts 120. This ensures that the only access to the resident side is through the opening in the arm insert 120 and insertion through the entire length of the sleeve 150.

FIG. 6 provides the details of the removable hardware stack up in relationship to the non-glass clear sheet 100, the molded urethane rubber arm inserts 120 and the antimicrobial medical grade PUL sleeves 150. Each arm insert 120 is installed from the visitor side of the device using sets of hardware consists of a ⅝″ machine screw 180, hex nut 190 and two plastic hinged snap cap hardware covers 140. In FIG. 6 the hardware covers 140 are shown closed. They are used to reduce unwanted access to the machine screws 180 while still providing a way for removing the sleeves 150 for washing or replacement. The threaded shaft of the machine screw 180 is inserted through the bottom ring of the hardware cover 140, then placed through the corresponding holes in the arm inserts 120, sleeve 150, sheet 100, through the bottom ring of the second hardware cover 140 and hex nut 190. Once all hardware sets have been installed and tightened, the hardware cover 140 lids can be snapped closed hiding the head of the machine screws 180.

FIG. 7 provides the details of the removable hardware stack up in relationship to the non-glass clear sheet 100 and HEPA hearing panels 130. The hearing panels 130 are installed from the resident side of the apparatus. The top set of hardware consists of a ⅜″ machine screw 200, powder coated aluminum heart clip 160, 5/16″ nylon spacer 210, hex nut 190, and plastic hinged snap cap hardware cover 140. The threaded shaft of the machine screw 200 is inserted through the hole in the heart clip 160, then through the spacer 210 before going through the corresponding hole in the non-glass clear sheet 100, the bottom ring of the hardware cover 140 and hex nut 190. The bottom set of hardware consists of a ⅞″ machine screw 220, plastic panel clip 170, 1/16″ thick neoprene rubber washer 230, hex nut 190, and hardware cover 140. The threaded shaft of the machine screw 220 is inserted through the holes in the panel clip 170 and washer 230 before going through the corresponding hole in the sheet 100, the bottom ring of the hardware cover 140 and the hex nut 190.

Once all hardware sets have been installed and tightened, the hardware cover 140 lids can be snapped closed hiding the head of the machine screws 200, 220. The heart clip 160 and panel clip 170 can be rotated out of the way to allow for the removal and replacement of the HEPA filter panel.

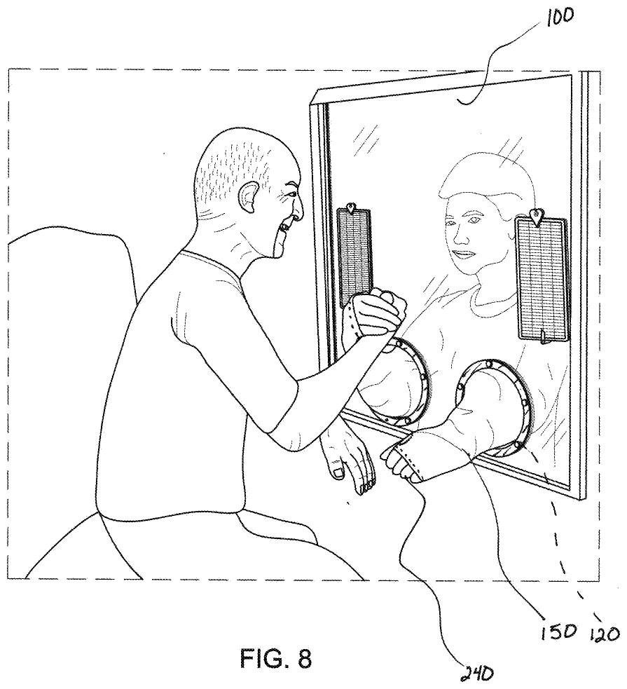

FIG. 8. Shows the window apparatus inserted in the screen track of an existing exterior facility window system per the method detailed in FIG. 9. An interior facility window can be used as another embodiment of this invention. The seated resident is shown clasping the visitor's gloved hand which has been inserted through the molded urethane rubber arm insert 120 and the antimicrobial medical grade PUL sleeve 150 which are securely fastened with removable hardware into the apertures the non-glass clear sheet 100. In another embodiment of this invention, both resident and visitor can stand, provided the window system selected is a suitable height. The visitor is shown wearing new, disposable gloves 240. New gloves are used for each visit and are sanitized prior to being inserted into the sleeves 150 per the steps detailed in FIG. 9. The visitor's arms are free to move about inside the facility while maintaining isolation from the outside environment.

FIG. 9 details the method for installation and use of the reach-through window apparatus. The installation method is detailed in steps A-M. The how to use method is detailed in steps O-Y.

A—several factors should be considered when selecting the site for enhanced window visits including ease of staffing, access for visitors and protection from the environment. The size of the reach-through window (RTW) should match the screen dimensions to within a 1/16″ for a proper fit following steps B-C. For those embodiments where the primary window track will be used, the measurement should be taken from that track. D—the RTW should be installed in the same manner as the existing screen. E—the RTW should fit firmly within the screen track; there should be a 1/16″ or greater overlap of the RTW with the track on all sides. F—if the RTW does not fit within the track, remove the PVC edge trim 110 from 1 or more sides and recheck. H—if the RTW fits firmly into the track but does not overlap, re-measure and re-order. I-J—if screen clips were provided and installed for the original screen, reinstall those clips. K-L—verify that the edge of the RTW abuts the screen track around the entire periphery. If not, apply 1 or more ½″ exterior hook and loop tabs between the RTW and the screen track. M—perform a final fit verification once any clips or tabs are in place to ensure that there are no gaps between the RTW and the screen track.

N—once the RTW is in place, the visitor can approach the window wearing new, size appropriate, disposable gloves without the need for a facemask. O—once the disposable gloves are in place, disinfect using facility approved and material compatible disinfectant. P—insert the gloved hands through the molded urethane rubber arm inserts 120 and into the antimicrobial medical grade PUL sleeve 150. Place the thumbs through the thumb holes to correctly position and anchor the hands in the sleeves 150. Q—prior to contact with the resident, disinfect the exposed portion of the disposable gloves using facility approved and material compatible disinfectant. R—the visitor and resident can now have a natural, mask-free conversation which includes the gift of touch. The visitor can also aid the resident with a variety of tasks including, but not limited to fixing cell phone issues, feeding, grooming, and giving a back rub. In another embodiment of the invention, the sleeves 150 can be inverted allowing the resident to don disposable gloves and reach through the device to the visitor side. This is helpful with small children and pets where hand insertion from the visitor side is not possible.

S-T—following the visit, disinfect the disposable gloves before retracting through the sleeves and discarding. Disinfect both sides of the RTW and all component using facility approved and material compatible disinfectant; sleeves should be disinfected both inside and out. V-Y if the RTW will be stored in place tie sleeves together before closing and locking the primary window. The RTW can also be easily removed and stored between visits.

Having thus described the preferred embodiment of the invention, we claim the following:

1. A window apparatus comprising: a non-glass clear sheet; a set of molded arm inserts removably secured to said sheet; medical grade protective fingerless sleeves removably secured between said sheet and said inserts; High-efficiency Particulate Air (HEPA) hearing panels removably secured to the said sheet; and a protective edge trim removably secured to the said sheet.

2. A window apparatus according to claim 1 where said sheet matches the size of the framed screen in the facility window system selected for visitation.

3. A window apparatus according to claim 2, wherein said sheet has apertures cut to accommodate said arm inserts and said hearing panels and a plurality of holes to accommodate said removeable hardware.

4. A window apparatus according to claim 2, wherein said sheet has the option of edge protective trim applied to the edges to ensure firm fit in the screen track.

5. A window apparatus according to claim 3, wherein said molded arm inserts are funnel-shaped with the outer collar providing gasketing between said arm inserts and said sheet and wherein the inner diameter provides access through apertures in said sheet.

6. A window apparatus according to claim 5, wherein said set of medical grade protective fingerless sleeves is secured between said sheet and said arm inserts with said removable hardware.

7. A window apparatus according to claim 6, wherein each said arm insert and said sleeves are secured by 5 or more sets of removable hardware consisting of a screw, nut, and snap cap hardware covers.

8. A window apparatus according to claim 3, wherein the hearing panels consist of readily available, off-the-shelf HEPA air filter cartridges wherein the outer edge provides a gasket between said panels and said sheet.

9. A window apparatus according to claim 8, wherein each said hearing panel is secured by removable hardware consisting of a set of a screws, nuts, snap cap hardware covers, panel clip, rubber washer, heart clip, and spacer.

10. A method of installation, use and storage of a reach-through window apparatus comprising:
a. installing the said apparatus into an existing facility window system without need for modification;
b. donning disposable gloves, disinfecting said gloves, reaching through the access ports in said window apparatus and into sleeves on the opposite side of the said window while maintaining medical isolation;
c. storing the said apparatus in place as part of the existing window system.

11. A method of claim 10 where the reach-through window is installed in the screen track of the facility window system once the screen is removed.

12. A method of claim 11 where the reach-through window once installed is secured using screen clips or levers, if any, used to secure the original screen.

13. A method of claim 11 where the abutment between the reach-through window and screen track is verified and exterior hook and loop tabs are inserted between said window and screen track if needed.

14. A method of claim 12 where the reach-through window and all components are disinfected using facility approved and material compatible disinfectant on both sides prior to each visit.

15. A method of claim 10 where the gloved, disinfected visitors' hands reach through the said sleeves and are positioned and secured by inserting the thumbs into the sleeve thumb holes.

16. A method of claim 15 where the gloved hands in position are disinfected prior to contact with the resident.

17. A method of claim 16 where the resident and visitor can make physical contact while maintaining a medical barrier.

18. A method of claim 17 where said gloves are disinfected using facility approved and material compatible disinfectant after the visit but prior to retracting them from the sleeve and discarding.

19. A method of claim 10 where the reach-through window is stored in place by closing and locking the primary window or removed following visitation hours.
